(19) United States
(12) Patent Application Publication
(10) Pub. No.: US 2023/0230058 A1
(43) Pub. Date: Jul. 20, 2023

(54) VISUAL CONTENT MANAGEMENT AND DISTRIBUTION SYSTEM AND METHOD

(71) Applicant: Eventshop, Inc., Brentwood, TN (US)

(72) Inventors: Spencer S. Combs, Brentwood, TN (US); Craig E. Casey, Minneapolis, MN (US); Trey D. Cushman, Nashville, TN (US); Connor T. Dwyer, Nashville, TN (US); Jeb Holmes, Nashville, TN (US); Jared J. Palmitier, Spring Hill, TN (US); Kyle L. Reeves, Thompsons Station, TN (US)

(21) Appl. No.: 18/095,562

(22) Filed: Jan. 11, 2023

Related U.S. Application Data
(60) Provisional application No. 63/298,421, filed on Jan. 11, 2022.

(51) Int. Cl. G06Q 20/12; G06Q 30/0601; G06Q 20/40; G06Q 30/0226

(52) U.S. Cl. CPC G06Q 20/1235; G06Q 20/4014; G06Q 30/0226; G06Q 30/0637; G06Q 30/0643

(57) ABSTRACT

A method and system provides for content management and distribution, including receiving a plurality of digital data files each digital data file including a visual content item, such as photographs. The method and system includes receiving event data associated with the digital data files, identifying an event captured in the visual content and receiving author data for the visual content. The method and system includes presenting the visual content of each the plurality of digital data files to an authorizing user, as well as receiving approval indicators for one or more of the digital data files, indicating approval by the authorizing user for use or distribution of the files. Therein, the method and system includes generating an approved content data set and distributing the approved visual content for loyalty, rewards, or commercial transactions.

### RELATED APPLICATIONS

This application is related to U.S. Provisional Pat. Application No. 63/298,421, filed Jan. 11, 2022, the contents of which are incorporated by reference herein in their entirety.

### FIELD OF THE INVENTION

The invention relates to generally to content management and more specifically to managing visual content, approving and curating collections of visual content, and creating customized items therewith.

### BACKGROUND

As a technology, digital photography has reached maturity: most commercial photography is now digital. However, systems for managing and sharing images are still developing. Many photographers use software like ADOBE LIGHTROOM® for managing and editing collections of digital images. However, once a photographer is ready to release her work to the client, the available systems for doing so often fall short.

The problem of what to do with finished commercial images is particularly acute in the area of event photography. Photographers are often hired or commissioned to take photographs of events. These events may be private events, such as weddings or parties, or they may be public events, including concerts, sporting events, galas, and fundraisers.

If the photographer is photographing an event for his or her own portfolio, or if there are no particular requirements or conditions imposed by the organizers, the photographer may simply release the photographs to the public for display and purchase. If the event in question is private, like a wedding, the photographer may release the photographs to the organizers, e.g., the bride and groom, who decide which photographs should be printed, and in what sizes. Websites like SMUGMUG® work well for general and light-commercial release of photographs, allowing photographers to show photographs to the public for viewing. Sites like this often allow photographs to be printed on a variety of media and objects.

However, large public events often pose particular challenges that the existing photo-release software platforms are ill-equipped to handle. For example, the representatives for a major musical artist may hire several photographers to document each performance in a multi-city tour. The photographers may tour with the artist, or different photographers may be hired for each city in the tour. With multiple photographers shooting, hundreds or thousands of photographs may be generated from a single performance.

Historically, of these hundreds or thousands of professional photos taken of a single performance, most never see the light of day. A token number of photographs may be released to news outlets, some may be used in promotional materials for the artist, and for particularly well-known artists, some additional or rare photographs may be published in biographies, picture books, or as part of other documentary efforts. Yet the vast majority of professional photographs that are taken remain under the control of the artist or her representatives, largely unseen by the public.

The reasons why most event photographs go unseen are both contractual and technical. Professional photography contracts usually specify that photographs of an event are the property of the artist, not the photographer; therefore, the photographer has no right to release the work publicly. Yet there is often no pathway for large-scale release of public-event photographs to the public - the existing direct-to-consumer photographic platforms are designed to serve photographers, not those who appear in the photographs.

### BRIEF DESCRIPTION

The method and system provides for content management and distribution. The method may be performed using one or more computing devices in a distributed network, including processing operations performed at a local and/or in a network or server-based environment.

The method and system includes receiving, via a first user interface, a plurality of digital data files each digital data file including a visual content item therein. The first user interface can be an application running on a mobile device or a stand-alone computer, or can be a browser-based or network-based application. The visual content can be any type of visual media, including for example photographs, videos.

The method and system includes receiving event data associated with the digital data files. The event data identifies an event associated with or the subject of the visual content. For example, if the event is a concert, the event data may indicate the artist or band performing at the event, the date of the event, the venue, tour information, etc. For example, if the event a sporting event, the event data may indicate the teams playing, the data of the event, the stadium, the name of the event or tournament, etc. The event data may be embedded within the digital data files as meta data, may be preprogrammed as part of the first user interface, for example a log-in screen requesting to upload data files for the designated event, or any other suitable means may be utilized.

The method and system includes receiving author data associated with the plurality of digital data files. In one embodiment, the author data identifies at least one user as authoring the visual content. In the example of a photograph, the author data can be the actual photographer taking the photos. In another example of a photograph, the author data can be a company that hired the photographer and has proprietary rights to the work product. The author data can further include proprietary rights associated with the visual content, proprietary rights including associations or allocations relating to financial renumerations associated with sale and/or use of the visual content.

The method and system includes presenting, via a second user interface, the visual content of each the plurality of digital data files to an authorizing user. The second user interface can be a stand-alone executable software running on a mobile or desktop computer, may be a network-based application such as running within a browser, or any other suitable software executable as recognized by a skilled artisan.

The method and system includes receiving, via the second user interface, an approval indicator for at least a portion of the digital data files, the approval indicator indicating approval by the authorizing user. Here, the authorizing user is actively authorizing one or more of the visual content items for use. The authorization may include additional processing operations for tracking digital rights management, as well as tracking royalties or other financial arrangements and rights associated with use. Therein, the approved content items are part of an approved content data set.

The method and system further includes distributing one or more the approved content, including tracking proprietary rights and accounting for distribution. This distribution can be via varying embodiments, including distributing for commercial transactions, loyalty programs, rewards, by ways of example.

In one embodiment, the distribution is to a web commerce interface, the method and system including displaying each digital data file in the approved content data set in a display template and a plurality of commercial items for purchase capable of having the visual content item displayed thereon.

The method and system provides for content upload, approval, and integration within a commercial website. The method and system can include additional embodiments for facilitating commercial transactions, including interfacing with consumers for viewing various content items, e.g. images, different commercial items, and dynamically viewing the content item displayed on the commercial item. Moreover, should a consumer select a different a content item and/or different commercial item, the dynamic display is updated.

For example, the content items may be 10 different images from a recent concert and the commercial items can be print items (e.g. posters) and apparel (e.g. t-shirt and hooded sweatshirts). The consumer can select a first image and a t-shirt, the display showing the t-shirt with the image displayed thereon. If the consumer swaps items, e.g. selecting a hooded sweatshirt, the display is updated for leave the image but now displayed on the sweatshirt. Similarly, if the user switches images, the consumer item remains the same and the merged item is updated now with the second selected image.

In one embodiment, the distribution is for transmitting the visual content to a fan, participant, consumer, or other individual and not necessarily tied directly to the purchase of additional items. For example, if the event is a concert, the distribution can be a reward or extra content made available for attendance to the event. In this example, the distribution can be to a viewer or other type of interface allowing for viewing the approved content.

Where distribution is not tied to a commercial transaction, proprietary rights and accounting can still be important factors. For example, even though a recipient may not spend new funds to access the content, royalties may still be due to the author. For example, even though the recipient may not spend new funds to access the content, a sponsor or other entity may pay royalties for the content distribution.

The present method and system includes additional embodiments and variations on the use of the uploaded and authorized content, as described in greater detail below. The method and system provides for dynamic upload and management of authored content, as well as facilitating commercial transactions using said content.

### BRIEF DESCRIPTION OF THE DRAWING

The invention will be described with respect to the following drawing figures, in which like numerals represent like features throughout the description, and in which:

FIG. 1 is a schematic diagram of a system according to one embodiment of the invention;

FIG. 2 is a schematic diagram illustrating the use of a single image with multiple templates to produce different products;

FIG. 3 is a schematic illustration of the tasks of a workflow for using a system like the system of FIG. 1;

FIG. 4 is a schematic illustration of the tasks of a method for applying identifiers to images and video for rights management;

FIGS. 5-9 illustrates sample screenshots of a commerce interface; and

FIGS. 10-11 illustrate sample screenshots of a content distribution interface.

### DETAILED DESCRIPTION

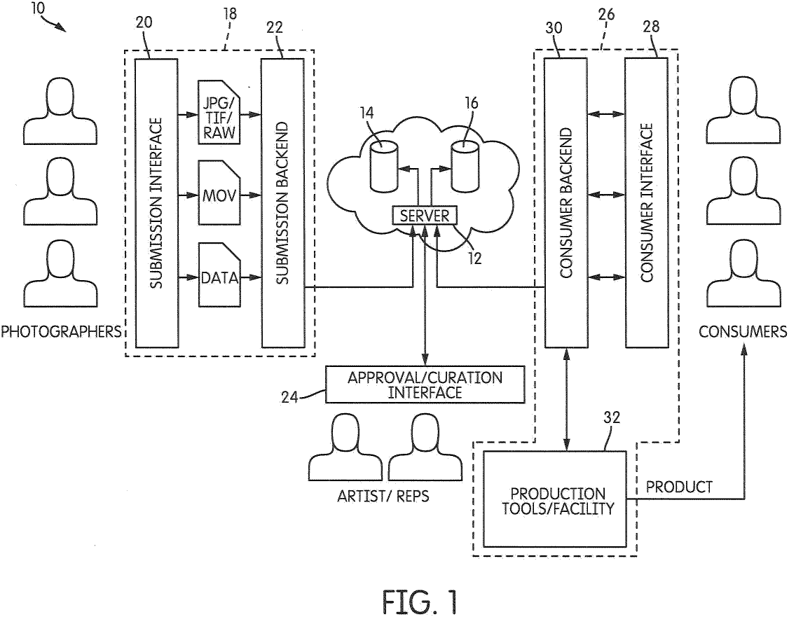

FIG. 1 is a schematic diagram of a system, generally indicated at 10, for managing media items and producing custom products using those media items. More specifically, system 10 of FIG. 1 is intended to serve three separate constituencies: photographers and videographers who document events, performing artists and their representatives, and consumers. Using system 10, photographers and videographers can share their work with the performing artists or representatives who hired them. The performing artists and their representatives can then review that work to determine which photographs, videos, or other media can and should be shared with the public. Once media is shared with the public, consumers can choose media items and have custom items manufactured using those media items.

System 10 is typically implemented in a combination of hardware and software. That is, system 10 is typically implemented by one or more computers or other such machines using software. The term “software” refers to sets of machine-readable executable instructions that, when executed by a machine, cause that machine, also referred to a processing device, to perform certain tasks. Software is typically stored in a nontransitory, machine-readable medium, such as a hard disk drive, a flash drive, system firmware, and the like.

As illustrated in FIG. 1, system 10 is a “cloud-based” system in which the server or servers 12 that execute many of the functions of system 10 are remote from the users of system 10 and are accessed via the Internet, another type of Wide-Area Network (WAN), or a local-area network (LAN). In a cloud-based system such as system 10, the server or servers 12 that execute many of the functions of system 10 may or may not be under the physical control of the operator of system 10. If the server or servers 12 are not under the control of the operator system 10, they may be shared servers on which the operator of system 10 has rented computing capability and storage space.

The server or servers 12 may be connected to any number of storage elements. In FIG. 1, the server or servers 12 are connected to two storage elements: a first storage element 14 that is intended to store large data files, such as image and video files, and a second storage element 16 that stores other operating information. The other operating information includes any and all information necessary to operate system 10. This may include metadata on the image and video files (e.g., image/video size, photographer, event information, approval data), print templates, and printing information, as well as information on the photographers, information on the artists/performers and their representatives, and other information, as may be described below in more detail. For example, the second storage element 16 may comprise a relational database or set of relational databases. Unstructured databases may also be used.

However, it is not necessary to bifurcate or separate storage into multiple elements 16, 18 in all embodiments. Rather, in at least some embodiments, a single storage element may be provided. For example, all of the data may be stored in a relational database or a set of relational databases. Ultimately, the precise methods and data structures used to store and retrieve information in system 10 are not critical, so long as they provide easy and, preferably, fast access to the necessary information.

System 10 has several sections, subsystems, or functional areas that cooperate to perform the overall functions of the system, but can also operate asynchronously of one another. The first is the photographer management subsystem, generally indicated at 18 in FIG. 1. The photographer management subsystem 18 includes a front-end submission interface 20 and a submission back-end 22. The front-end submission interface 20 includes all functionality necessary to qualify and establish accounts for event photographers and allow photographers to upload photographs and provide information about those photographs. The submission back-end 22 receives the image data and processes it for both storage and use in other parts of system 10.

The submission interface 20 may be implemented as an Internet website that allows photographers to establish accounts, log in, and upload and describe images. The submission interface 20 may also be implemented as an application or app on a computing device, such as a personal computer, a tablet computer, or a smart phone that uses, e.g., a web API to communicate with system 10. In some cases, the app may be a “plug in” to a photography application, such as PHOTOSHOP® or LIGHTROOM®, that allows photographs to be exported directly into system 10 with minimal further action from the user. The submission interface 20 may also be relatively passive for the user. For example, it may be an application that automatically uploads and processes files that are placed in a certain folder or directory on the computing device.

As this description implies, the submission interface 20 is implemented in software, and in a typical implementation, there are usually portions that are executed on the server 12 and portions that are executed on the client-side. In the content management system, the interface 20 can is the first user interface, receiving the generated visual content. The submission back-end 22, by contrast, is typically implemented entirely on the server-side.

The submission back-end 22 is generally responsible for checking the input from the submission interface 20. For example, the submission back-end 22 may check the format, size, and resolution of the images or videos to confirm that they meet predefined standards and may reject those images and videos that do not meet those standards. The submission back-end 22 may also collect and store data supplied by the submission front-end 20 and associate it with the uploaded images and videos, either by inserting metadata directly into image and video files, if that is possible, or by storing the data in the second storage element 16 in a manner that associates it with particular images and videos. The submission back-end 22 may also be responsible for certain tasks depending on the implementation. For example, the submission back-end 22 may prepare thumbnail or preview images from the uploaded images or videos. In some cases, the submission back-end 22 may re-size images and videos in general.

Generally speaking, system 10 may accept images in lossless or lossy formats. For example, the JPEG file format may be used because of the relatively small size and large color palette of its images, despite the fact that JPEG compression can cause loss of image quality. System 10 may also allow upload of lossless formats, like TIFF and RAW. System 10 may allow videos to be uploaded in a single format, using a single codec, or in a variety of formats and codecs.

It should be understood that although the photographer management subsystem 18 is described here as being divided conceptually into a front-end interface 20 and a back-end 22, functions may be divided between the two in a way that is different than that described here. Moreover, in some cases, there may be no division between the two: the application that provides the interface for image and video submission may perform all of the functions of the submission back-end 22, providing system 10 with all of the necessary data in the necessary formats for direct storage by the server 12 and its storage elements 14, 16.

Fundamentally, when the submission back-end 22 finishes its work, the images and videos from the photographers have been received and associated with a particular photographer and a particular event. System 10 is configured to manage many photographers and many events simultaneously. One difference between system 10 and traditional image-sharing and video-sharing systems is that once the images and videos are uploaded, they are not immediately released to the public. Instead, system 10 allows appropriate authorities to review the uploaded images and video and decide what is to be released and what is not.

As part of the data upload process, the method and system receives event data. The event data relates to the underlying event where the visual content is being captured. The event data can include any number of data fields, including the name of artists, teams, league, stadium, venue, date, tour name, sponsor details, by way of example. The event data can be uploaded as part of the first user interface or can be associated with uploaded content at any suitable point in time. For example, one embodiment can include in the first user interface selecting a particular event as part of the data upload process, this then associated with the data files with the event data. In another embodiment, data files may be uploaded and later grouped or referenced to specific events. In another embodiment, meta data may be associated with the data files, for example preset meta data associated with the data files at time of capture.

When the data files are uploaded, author data is associated therewith. Similar to the event data, author data can be defined during the upload process on a per data file basis. In one embodiment, the author data can be defined by a user login or other credential for accessing the first user interface to upload content. Another embodiment can include uploading the data files and then adding or associating author data.

Author data can include any suitable type of data that indicates authorship rights associated with the content. For example, authorship may be a specific photographer and/or an organization for which the photographer works. For example, authorship may be a designated organization or association commissioning the visual content capture. One example can be an artist hiring freelance photographers at a concert to take pictures, here the freelance photographers may have individual rights to the captured content. One example can be a sports league hiring photographers to capture images on behalf of the league, authorship rights resting in the league based on a contractual relationship. One example can be a news organization hiring photographers and granted access to an event, authorship rights resting in the news organization.

In one embodiment, author data includes or is associated with proprietary data. The proprietary data relates to one or more: ownership rights, authorship rights, publication rights, naming rights, image rights, likeness rights, licensing rights, and any other suitable rights relating to compensation. For example, proprietary rights may be associated with a sports team or organization receiving a royalty for use of the content. For example, proprietary rights may be associated with a band or artist receiving a royalty for use of their images, videos, songs, etc. For example, proprietary rights may be associated with a name, image, or likeness for an athlete captured within the event. For example, proprietary rights may be associated with a license or royalty for a photographer or videographer for capturing the content. For example, proprietary rights may be associated with a revenue-sharing or arrangement between performers, sports teams, sports leagues, venues, etc.

Specifically, system 10 provides an approval/curation interface 24, the second of the three subsystems of system 10. The approval/curation interface 24 allows an artist or her representatives to establish an account, define events or performances, and dictate which photographers or videographers are permitted to upload images and video for that event. Once images are uploaded by the photographers and videographers as described above, the approval/curation interface 24 allows the artist or her designated representatives to approve images and video for public release via system 10, and to curate images. In one embodiment, these operations can be performed via the second user interface.

Thus, the approval/curation interface 24 provides some of the same functionality as the submission interface 20, including the creation and management of user accounts. In this case, the user accounts belong to artists or their designated representatives. System 10 may use validation routines or manual validation techniques to confirm that users who have “approval” accounts are actually authorized to speak for a particular artist or to make decisions for a particular performance or event, or for a group of such performances or events. With system 10 and the approval/curation interface 24, one user or group of users may be designated as having the rights approve photographs and videos for all performances or events involving a particular artist, or for only a subset of performances or events involving that artist. Users of the approval/curation interface 24 may have approval rights associated with several artists, just as a single agent or promoter may serve multiple artists.

Using the approval/curation interface 24, a reviewing user may be permitted to approve or deny uploaded photographs or videos, select favorites, and download individual images or videos for further use by the artist. In some cases, a reviewing user may be permitted to approve or deny uploaded photographs or videos for specific purposes. By way of example, but not expressly limiting in nature, one example can be designating images solely for use in printed publication uses, e.g. a poster or framed art, e.g. if the image quality or coloring is likely to be degraded by printing on fabric.

When a content item is approved, from a data management perspective, the approval is representative by an approval indicator data field. In one embodiment, the approval indicator can be a true or false value, true indicating the image is approved for additional use and false indicating denial of approval. In further embodiments, approval indicator data fields can be conditional or restricted, for example restricting approval for predefined uses. One example can be conditional or restricted approval, approving content use for electronic image distribution but not for inclusion with printed or physical items.

The approval/curation interface 24, like the submission interface 20, may be implemented in software as a website or as an app on a device that uses a web API or another such technology to communicate with the rest of system 10. The approval/curation interface 24 may also be a plug-in to photograph or video management software.

In one embodiment for managing content, approved content can be designated within an approved content data set. The approved content data set is a subset of the full uploaded data set consisting only of the approved images.

Approved images and videos in the approved content data set may be put to a variety of uses. For example, approved collections of images and videos may be released to media outlets, used for promotions, and used to produce stock merchandise. However, system 10 also allows approved images to be used to produce custom merchandise on demand for users.

For example, a fan may have attended a concert May 24, 2022 in Milwaukee, Wisconsin. Using system 10, she can select from the available concert photographs for that particular artist taken at that particular concert, decide what form of merchandise she wants (e.g., photographic print, t-shirt, mug, etc.), choose a particular look or template for the end product, and have that merchandise manufactured on demand. While much of the merchandise may be physical products based on the images and video that are produced by the photographers, custom products created by system 10 may be electronic or virtual. For example, a fan may select an electronic slideshow or compilation of photographs, an electronic version of an image for display in a digital frame, or a signed or authenticated version of an image or video, such as an image or video in nonfungible token (NFT) form.

Templates allow the available images and video clips to be used in a variety of contexts and on a variety of products. A template may control the physical aspects of the image or video clip (e.g., the image size or crop, the image resolution, any applied filters or image adjustments), the aesthetic look of the final product, or both.

The commerce interface provides for commercial interactions using the approved visual content. The commercial transactions can include physical items or virtual items. The commerce interface uses at least a portion of the approved content data and generates a dynamic display of content available for purchase or acquisition.

In one example, the commerce interface can be accessed by a fan having attended the event seeking to purchase a t-shirt with a photo from the event. Here, the fan can view various t-shirt options and different images within the approved content data set. Dynamically, the fan can select different images and see how they appear on the t-shirt, eventually selecting both a physical item and an image. The commerce interface can then complete the transaction for purchasing the custom-made t-shirt.

In one example, the commerce interface can include additional fan-content made available as a reward for attending the event. This can include accessing the interface with the approved content and the ability to view or download approved content. For example, approved content may include song sung at the concert and the user granted a download of the performance. For example, approved content may include an image of a memorable play at a sporting event, the user granted a download of the image.

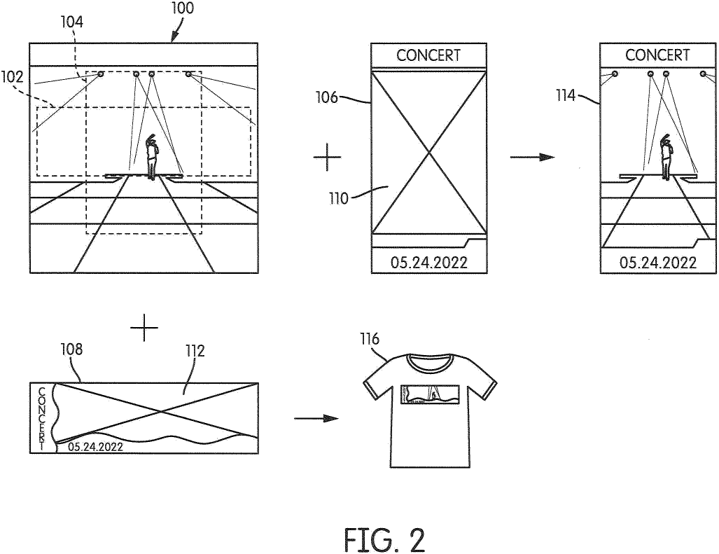

FIG. 2 illustrates applying a template. Specifically, FIG. 2 shows an approved image 100. The approved image 100 is shown with two possible crops, indicated as 102 and 104. Crop 102 renders a portion of the approved image 100 in a landscape aspect ratio and crop 104 renders a portion of the approved image 100 in a portrait aspect ratio.

FIG. 2 also illustrates two different templates 106, 108 that may be applied to the approved image 100. In this case, each template 106, 108 includes design elements that specify the nature and date of the event or performance. Each template 106, 108 also a specific crop 102, 104 and provides an area 110, 112 for image insertion. Notably, as can be appreciated from FIG. 2, the same approved image 100 with a different template 106, 108 may result in an entirely different look or product.

The first template 106 in this example is a template for making a poster print of an image, complete with the nature and date of the event or performance. As shown in FIG. 2, when the cropped portion 104 of the approved image 100 is inserted into the template 106, the result is a poster product 114 that includes the cropped portion 104 of the approved image 100 and the elements of the first template 106.

In similar fashion, the second template 108 in this example is a template for making a t-shirt. This particular template 108 is set up to use the landscape crop 102 of the approved image 100, and has an area 112 sized for that crop 102. As shown, when the landscape crop 102 of the approved image 100 is inserted into the second template 108, the result is suitable for printing, e.g., by screen-printing, on a t-shirt.

As those of skill in the art will appreciate, there are many ways of creating image templates and/or compositing features onto images. Templates may be created in vector or raster forms and images added to them by any of a number of readily-available image manipulation libraries. For example, a template could be created in a vector drawing program, such as ADOBE ILLUSTRATOR® and exported to a PNG raster graphics format, with the area intended for the image rendered as a transparent area within the PNG file.

At the time that an image is approved for publication and use, or at any time thereafter, the optimal crop or aspect ratio for each template and each type of product may be established for each image. In some cases, cropped, template-ready forms of the approved images 100 may be created and stored separately. The pre-production of appropriately-cropped, template-ready versions of the approved images 100 may avoid the necessity of cropping an approved image 100 anew each time a product is to be produced with that image.

Templates 106, 108 may be created by an artist, by her representatives, or by designers. Templates created by external designers may be subject to the same kind of approval process as images and video, and although not shown in FIG. 1, an interface could be provided in a system like system 10 that allows for upload and approval of templates 106, 108.

In one embodiment, a template may include an overlay with content relating to the event data. For example, an overlay can include a concert series logo and the date of the event. For example, an overlay can include a third-party advertiser or advertisement. The overlay provides for display of the photo with the overlay content added thereto.

With respect to the illustration of system 100 in FIG. 1, the manufacture of products using approved images 100 is handled by the production management subsystem, shown generally at 26. The production management subsystem 26 includes a consumer interface 28, also referred to as a commerce interface, and a consumer or production back-end 30. The production back-end 30 is associated with production tools or facilities 32 that produce products for consumers.

The consumer interface 28 is implemented in much the same way as other interfaces 20, 24 of system 10: typically as a website or app that uses a web API to communicate with the rest of system 10. Functionally, the consumer interface 28 allows a user to establish an account, view approved images 100, choose a type of product and an appropriate template, and order merchandise with the selected image or images rendered according to the selected template.

The production back-end 30 creates or supplies information for the consumer interface 28, retrieving, for example, the available approved images 100 and the available templates 106, 108. The production back-end 30 may, for example, implement rules that prevent a consumer from ordering merchandise using a template 106, 108 that is inappropriate for the merchandise. A template 106, 108 may be inappropriate for a particular type of merchandise either because it is not possible to reproduce that template 106, 108 on that type of merchandise, because the template 106, 108 has not been approved for use on that type of merchandise, or for other reasons.

In one embodiment, the production back-end 30 is also responsible for any alteration or correction of approved images 100 or templates 106, 108 that may be necessary to put a merchandise order into production. This may include, e.g., resizing a template 106, 108 for a particular product, confirming that the size or resolution of an approved image 100 is sufficient for and/or compatible with a template 106, 108, and other such basic image- or template-manipulation operations. When the consumer has chosen an approved image or images 100, a template 106, 108, and a piece of merchandise and the production back-end 30 has processed the order, the relevant information is sent to the production tools or facility 32 for actual production.

As with the other subsystems 18, 24 described here, the allocation of functions and responsibilities between the consumer interface 28, the production back-end 30 and the production tools 32 may vary from embodiment to embodiment and implementation to implementation. As above, some of the functions ascribed to the production back-end 30 may be performed by the consumer interface 28. Additionally, in this case, image resolution, sizing, half-toning, and other such manufacturing details may be handled by the production tools 32.

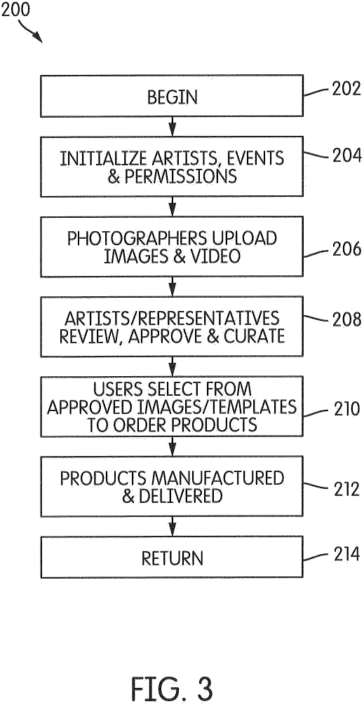

FIG. 3 is a schematic flow diagram that summarizes an exemplary workflow, generally indicated at 200, using a system like system 10. Workflow 200 begins at 202 and continues with task 204. In task 204, the system is initialized. This may include a variety of tasks, but generally involves defining one or more events and one or more artists or other responsible parties for each of the events. If the photographers or videographers and reviewing parties are known when task 204 begins, accounts may be created and permissions or associations assigned. If not, this can be done as individual accounts are established by the photographers, videographers, artists and representatives, and fans.

Once events and artists are established in task 204, workflow 200 continues with task 206, in which photographers and videographers are free to upload images and video and to associate those images and videos with specific events. As was noted above, at the time of upload, system 10 may check the images and video to ensure that they meet specific technical standards (e.g, size, resolution, format, codec, etc.), and may reject any that do not without the need for further review.

In one embodiment, the operations of step 206 can include, from an executable application or network-based processor perspective: receiving the digital files with the visual content items, e.g. photos or videos; receiving the event data associated with the digital data files; and receiving the author data.

When images and video are available for review, they are presented to artists and/or their representatives for review in task 208. For example, artist representatives may receive notifications through the approval/curation interface 24 that there are images or videos to review and approve, or they may get notifications through other means of communication, e.g., SMS text message, e-mail, etc. Images and videos may be offered for review as they are uploaded, in batches, at particular intervals of time, or in any other way that is convenient.

In one embodiment, the operations of step 208 can include: presenting the visual content items in a user interface; receipt of approval indicators relating to one or more of the visual content items; and generating the approved content data set including the content items for which approval was electronically received.

Once images and videos have been approved for release and use in merchandise, workflow 200 continues with task 210. In task 210, having established appropriate accounts, users can select images, templates, and types of merchandise to order custom products. Those products are produced and delivered in task 212 before workflow 200 concludes at 214.

In one embodiment, step 210 can include web commerce interface operations, including displaying one or more of the approved content items and commercial items for purchase with the image displayed thereon. Moreover, in facilitating the commercial transaction, the method includes approving commercial transactions to purchase commercial items with visual content thereon.

Workflow 200 presents only a brief overview of how a system like system 10 might be used. Considerable variation and numerous sub-tasks may be found in specific implementations.

Although much of this description refers to production-on-demand of merchandise, there is no requirement that every piece of merchandise sold through the consumer interface 28 be made-on-demand. Rather, some more general merchandise may be made and stocked, using the images and templates in system 10. For example, an artist or her representatives may request a batch of t-shirts made with a particular image and template for personal use or for sales at event venues.

In one embodiment, rights associated with the visual content are straightforward - the photographers are contracted by a single party that has the rights to the images and approves them for publication and use in a system like system 10. That may not be the case in all embodiments. For example, two artists may perform in a concert, and the representatives of each artist may need to review and approve images for release, decide which templates are acceptable for use with the images, and in some cases, how to divide any revenue that may be generated. The problem compounds when there are multiple artists or subjects in an image, in which case there may need to be multiple arrangements for dealing with approvals, acceptable templates for particular images, and division of any revenue that may be generated. In some situations, this may need to be done on an image-by-image basis for hundreds or thousands of images.

Systems and methods according to embodiments of the invention need not be limited to the performing arts, and other contexts may raise these kinds of issues as well. Sporting events are one particular example - laws and sport regulatory bodies are increasingly recognizing the rights of athletes to control their names, images, and likenesses in commercial pursuits. This means that if images are taken of a professional or amateur sporting event, each of the individual athletes or their representatives may need to approve the resulting images and templates for release and use in a system like system 10. In some cases, existing agreements may dictate how situations like this are handled, but that is not always the case.

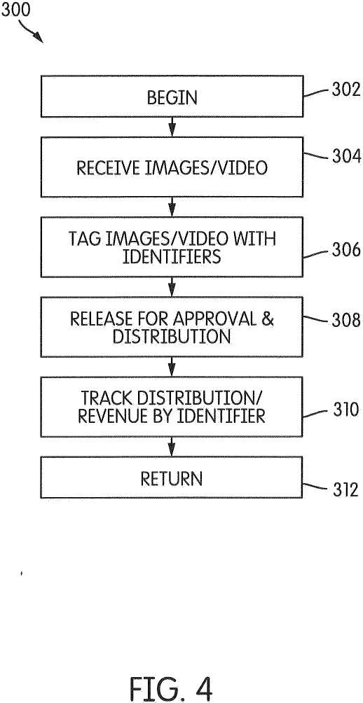

FIG. 4 is a schematic flow diagram of a method, generally indicated at 300, that addresses situations like those described above. Method 300 begins at 302 and continues in task 304. In task 304, a photographer uploads images and video to a system like system 10. This is done essentially as described above, including the first user interface. Method 300 continues with task 306.

Method 300 assumes that the uploaded images and video include multiple subjects, each of which may require a different approval entity or process. Method 300 also assumes that the templates, distribution channels, and any potential revenue sharing may be different for each of the subjects in the images and video. For that reason, method 300 includes a mechanism to track which subjects are in which images and video. As shown in task 306, images and video are tagged with identifiers that identify the subject(s) in the images and video. These identifiers may be in any form, and they may be stored as metadata in the image or video files themselves, or they may be stored in a separate repository and associated with the respective image and video files. In some cases, the identifiers may be the kinds of hashtags that are used as search indexes in a variety of media: #johndoe, #janedoe, #redteam, #blueteam, etc.

In one embodiment, the tagged data can include the event data, as noted above.

The identifiers applied in task 306 will be as specific as they need to be to facilitate indexing and searching of the images and video, as well as to satisfy rights-management needs. For example, with images of a musical concert, the images and video may be tagged with the name of the group, the date of the concert, the location of the concert, and the names of the individuals in the image or video. In the case of video, or where part of an artistic work is recorded in an image or video (e.g., a copyrighted image, video, piece of music, or other such work), the image or video may also be tagged with the name of the song or other artistic work. In the case of a sporting event, the image or video might be tagged with the names of the teams, the date and location of the event, the names of the individuals in the image or video, a description of what those individuals are doing (e.g., in the case of a basketball game, #slamdunk, #assist, #three-pointer, #block, #rebound, etc.), and an identifier for any separately-copyrighted work that may be in the image or video. Tagging the image or video with an identifier of any work of art or separately-copyrightable piece seen in the image or video may assist with rights management and royalty payments. In one embodiment, this may include the proprietary data associated with the visual content.

The identifiers applied in task 306 may be applied in any number of ways. In some cases, the photographer may apply metadata to the images and video before uploading them, and that metadata may be uploaded with the media files. In other cases, the identifiers may be applied manually. In some cases, some identifiers may be applied automatically while others are applied manually, e.g., the date of the event and names of the competing teams may be applied automatically, while other identifiers are applied manually. In yet other cases, techniques like image recognition may be used to recognize the faces of people and groups and to add appropriate identifiers. For example, a classifier may be trained on the faces of the groups and individuals who are likely to be in the images and video that are uploaded.

Once the images and video are tagged with identifiers in task 306, in task 308 they are released to and for the kind of approval and distribution processes described above with respect to method 200. That is, the images and video may be sorted and sent by tag to different appropriate entities for approval. As was described above, those entities would typically have credentials to use a system like system 10 and would perform the approval process using, e.g., a web- or app-based interface. However, approvals may be garnered in other ways. Prior to or during that approval process, certain templates 106, 108 may be designated for use with images and video having specific tags.

Here, authorization is performed by presenting the visual content via the second user interface and receiving approvals for one or more of the content items. The second user interface is a general term for the interface used for content authorization. Where content is distributed to different users for different authorizations, each user can access and review the content via their own individual software instantiation of the user interface.

Method 308 continues with task 310, which typically occurs concurrently with at least a portion of task 308. That is, as images and video are distributed for merchandise manufacture, publicity, and other uses, the system tracks the uses and dispositions of the images and video by identifier. This tracking information can be used for a number of purposes. Here, the visual content, e.g. images and/or videos, are available via a commerce interface.

The method and system further allows for digital rights management and tracking - the individuals and groups in the images can be compensated for the use of their likenesses in accordance with underlying agreements and legal obligations. Additionally, if the images or videos include artistic works copyrighted by third parties, those parties can be compensated appropriately. Further to the examples given above, if, e.g., a video contains a portion of a song, the songwriter or songwriters can be compensated for the use of that song if the video is appropriately tagged. The tracking of task 310 can also help to collect metrics that may be of interest to both the subjects in the images and video and the operator of method 300, like the amount of revenue derived from each image and each subject, the products and image/product combinations that are most popular, etc. Method 300 returns at task 312.

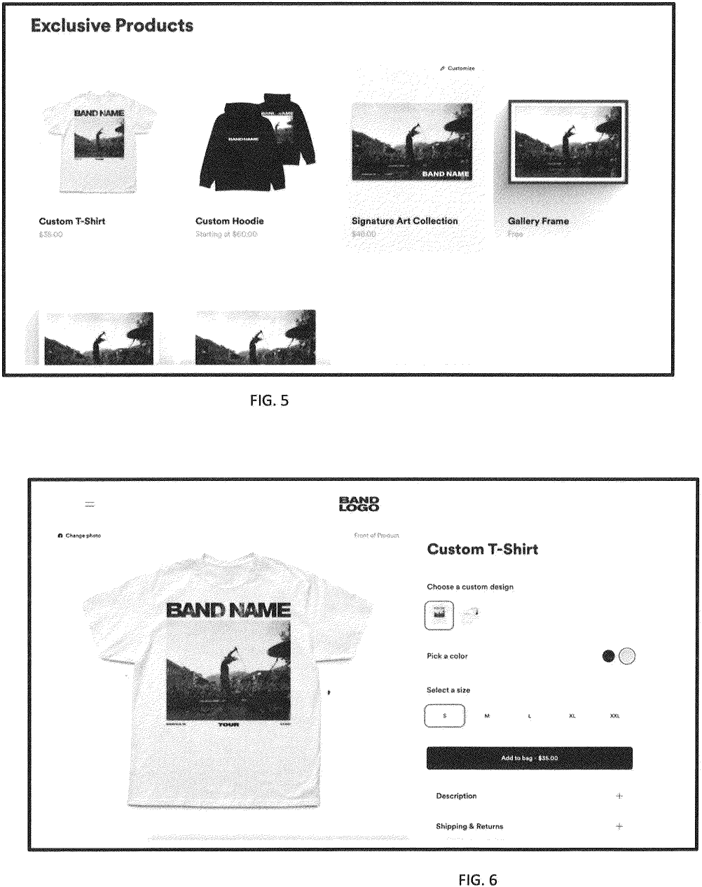

For further illustration, FIGS. 5-9 are sample screenshots of a commerce interface. The commerce interface includes approved visual content populated consistent with the techniques described above. Moreover, the commerce interface provides for integrating the content items with commercial items for purchase.

Sample screenshot of FIG. 5 shows a landing page allowing for a fan or consumer to view a catalog of items. In this example, items include t-shirts, hoodies, art, framed content, among others. These content items are customized items via the interface.

FIG. 6 screenshot illustrates a user selection of a t-shirt. The shirt, in this embodiment has two color options and has a default image. Further includes is an overlay associated with the display of the image, including the band name, tour information, and the date or dates of the event. In one embodiment, the image on the t-shirt is from the approved content list.

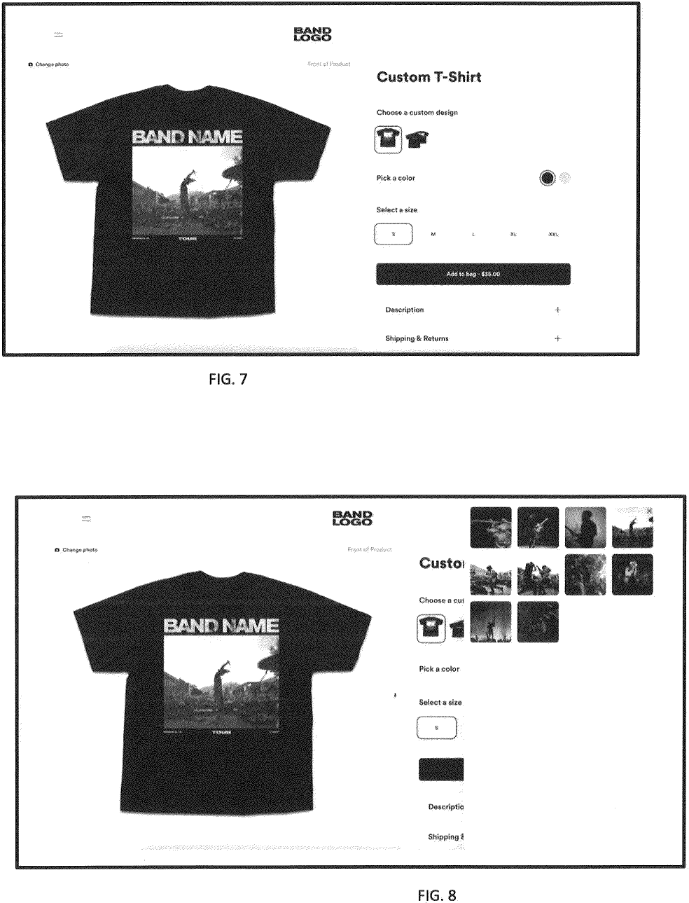

Via the commerce interface, the user can change the shirt color, as illustrated in sample screenshot of FIG. 7. In this example, the t-shirt color is changed from white to black and the overlay color is modified from black to white.

For further interaction, FIG. 8 illustrates a sample screenshot for the user to select a different image. In the sidebar display, in this example, eight approved images are available. One or more of these images are part of the approved content data set and available for inclusion in the commercial transaction, here being printed on top of the t-shirt.

In the FIGS. 6-8 sample screenshots, the selected or default image is a singer standing in the middle of the stage. The user can manually select a different image using the sidebar interaction in the interface of FIG. 8.

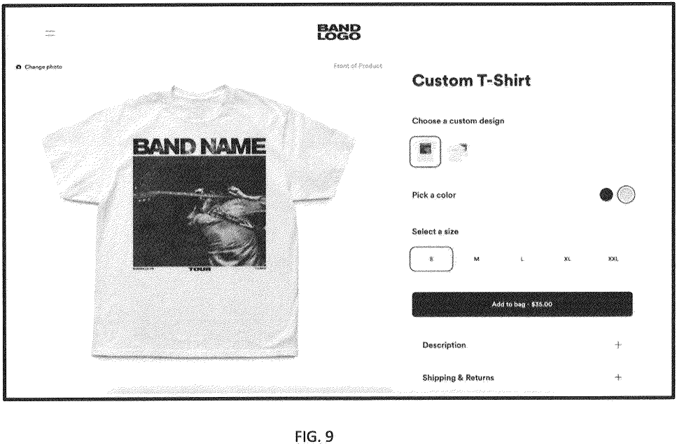

In the exemplary embodiment, the user selects an image of a guitarist. This image selection can then update the product, here a t-shirt, and overlay the newly selected image in the product display. FIG. 9 illustrates the sample screenshot of the updated t-shirt with a changed image. In one embodiment, the color of the shirt may be dynamically modified back to white based on recognition of the dark tones of the image or in another embodiment the user could manually select a white or light t-shirt over the dark t-shirt of earlier screenshots.

As part of this interaction, the user can dynamically jump between products (FIG. 5), versions of the products (FIGS. 6, 7, and 9), as well as visual content on the product (FIG. 8). The user can custom design a unique commemorative product.

While not expressly illustrated, the user may complete the transaction by finalizing the product and image. In one embodiment, the user can then approve the custom-designed product and check-out via the commerce interface. Because the visual content, here the graphics, are tracked via the content management system, the commerce interface dynamically tracks proprietary rights associated with the visual content and tracks royalties or other monies due.

For example, a user may purchase a t-shirt for $35, having selected a specific image. The proprietary rights for the image allocate a $2 royalty for the photographer who took the image and a $2 royalty for the artist captured by the image. Therefore, the present method and system can dynamically track these royalties and amounts due concurrent with the processing of commercial transaction.

Herein, the method and system provides a complete platform for content upload, authorization, commercial activities, and managing royalty accruing therefrom.

The above FIGS. 5-9 screenshots relate to pictures and commercial transactions. The content management and distribution system can additionally manage content not directly relating to financial transactions, but rather to fan loyalty or bonus content.

For example, after a live concert, fans can be rewarded with additional content. One type of additional content can be a video of a song performed at the concert. Another type of additional content can be exclusive images from the event as captured by photographers or videographers. The content is processed consistent with the approved method and system, generating the approved content data set.

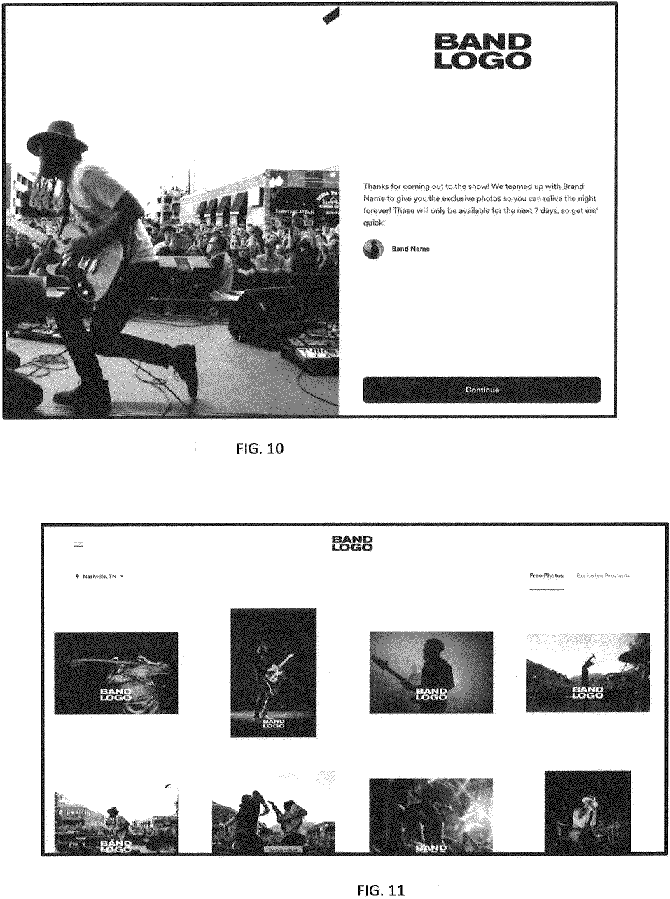

FIG. 10 illustrates a sample screen shot of a content access user interface. In one embodiment, access to the user interface may be predicated on attendance at the event. For example, a special code may be distributed at the event, such as displayed on a large screen television, printed in a program guide, displayed on posters around the arena, etc.

In this sample FIG. 10 user interface, the fan is presented with the ability to access the additional content. In this embodiment, the content is free as a reward for the user attending concert. The interface landing page of FIG. 10 can be dynamically customized for the specific event, relating to the band (as one example), date of the event, and can even include a landing image from the event itself.

Upon entering the user interface, FIG. 11 illustrates a sample screenshot of additional content made available. This content is various images acquiring during the event, as captured, uploaded, and approved in the present system and method.

In one embodiment, the images are provided with an image overlay including the name of the band. Any other overlay details can be included. For example, the additional event content can be sponsored, the overlay including an advertisement to the sponsoring entity, as well as the name of the tour, the date of the event, etc.

Via the interface of FIG. 11, the user can view and access the additional images. In one embodiment, this image display can lead into the commerce interface of FIG. 5, if the user really likes an image they may wish to purchase a product with the image on it.

Moreover, where the image display of FIG. 11 may not include a direct consumer transaction, various embodiments can include financial elements. For instance, the user may restricted to viewing an image for free, but can download the image with overlay or watermark elements removed for a set fee. In another instance, the sponsoring entity may pay a royalty or other fee for each image access. Therefore, the commerce interface of FIGS. 10-11 can include financial transaction and tracking monies, as well as other proprietary rights for the content made available therethrough.

For distributing approved content for user output instead of commercial transactions, the method and system still tracks the proprietary rights and accounts for distribution. In embodiments where content is distributed free to the recipient, authors and other entities may still receive royalty payments or other renumerations. For example, a third party may sponsor the additional content distribution, paying a flat fee or a per-content royalty. Therefore, even thought a direct consumer transaction may not take place, tracking proprietary rights remain within the present method and system.

In further embodiments, content distribution can be tied to other forms of monetization, including data collection techniques. For example, if a concert-goer wishes to receive the approved visual content, they provide an email address and other identifying information. This information can be collected, having a value. Therefore, the tracking of proprietary rights and accounting for distribution can account for data collection and databases of information, whether usable by the artist, a management company, one or more sponsors, a third-party, etc.

While the invention has been described with respect to certain embodiments, the description is intended to be exemplary, rather than limiting. Modifications and changes may be made within the scope of the invention.

FIGS. 1 through 11 are conceptual illustrations allowing for an explanation of the present invention. Notably, the figures and examples above are not meant to limit the scope of the present invention to a single embodiment, as other embodiments are possible by way of interchange of some or all of the described or illustrated elements. Moreover, where certain elements of the present invention can be partially or fully implemented using known components, only those portions of such known components that are necessary for an understanding of the present invention are described, and detailed descriptions of other portions of such known components are omitted so as not to obscure the invention. In the present specification, an embodiment showing a singular component should not necessarily be limited to other embodiments including a plurality of the same component, and vice-versa, unless explicitly stated otherwise herein. Moreover, Applicant does not intend for any term in the specification or claims to be ascribed an uncommon or special meaning unless explicitly set forth as such. Further, the present invention encompasses present and future known equivalents to the known components referred to herein by way of illustration.

The foregoing description of the specific embodiments so fully reveals the general nature of the invention that others can, by applying knowledge within the skill of the relevant art(s) (including the contents of the documents cited and incorporated by reference herein), readily modify and/or adapt for various applications such specific embodiments, without undue experimentation, without departing from the general concept of the present invention. Such adaptations and modifications are therefore intended to be within the meaning and range of equivalents of the disclosed embodiments, based on the teaching and guidance presented herein. As used herein, executable operations and executable instructions can be performed based on transmission to one or more processing devices via storage in a non-transitory computer readable medium.

What is claimed is:

1. A content management and distribution method comprising:
receiving, via a first user interface, a plurality of data files, each data file including visual content therein;
receiving event data associated with the data files, the event data identifying an event associated with the visual content;
receiving author data associated with the plurality of digital data files, the author data identifying proprietary rights associated with the visual content;
presenting, via a second user interface, the visual content of each the plurality of data files to an authorizing user;
receiving, via the second user interface, approval indicators for at least a portion of the plurality of data files, the approval indicator indicating approval by the authorizing user for authorizing use of the visual content;
generating an approved content data set including each of the plurality data files receiving the approval indicators; and
distributing at least one of the plurality of data files from the approved content data set including tracking the proprietary rights associated therewith and accounting for the distribution thereof.

2. The method of claim 1, wherein the distributing is to a commerce interface, the method further comprising:
displaying, in the commerce interface, the visual content of the one or more data files in the approved content data set in a display template and a plurality of commercial items for purchase capable of having the visual content imposed thereon.

3. The method of claim 2 further comprising:
approving at least one commercial transaction, via the commerce interface, for purchase of one of the plurality of commercial items having the visual content; and
tracking at least one royalty allocation based on the commercial transaction and the proprietary rights associated with the visual content.

4. The method of claim 2 further comprising:
within the commerce interface:
receiving a first selection of one of the commercial items;
receiving a second selection of one of the visual content items;
generating a graphical display of the commercial item of the item of the first selection having the visual content item of the second selection overlayed thereon;
receiving a third selection of another visual content item different from the visual content item of the second selection; and
updating the graphical display of the commercial item replacing the item of the second selection with the item of third selection.

5. The method of claim 2 further comprising:
applying an overlay template associating the visual content with a graphical indicator of the event; and
wherein the commercial transaction includes the visual content with the graphical indicator of the event.

6. The method of claim 1, wherein the proprietary rights associated with the visual content include at least one of: authorship rights relating to acquisition of the visual content; name, image, and likeness rights relating to a subject captured in the visual content; performance rights relating to an artist captured in the visual content; and organization rights relating to an organization commissioning the event.

7. The method of claim 1 further comprising:
generating a unique identifier associated with the event;
distributing the unique identifier to a recipient based on attendance at the event by the recipient; and
authorizing access for the consumer to the web commerce interface based on the unique identifier.

8. The method of claim 1, wherein tracking the proprietary rights includes:
determining a royalty rate associated with the proprietary rights;
tracking fees generated using visual content of the approved content data set; and
accounting for royalty payments based on the royalty rate.

9. The method of claim 1, wherein the distributing of the at least one of the plurality of data files includes:
authorizing access for a recipient to view visual content within the approved content data set.

10. The method of claim 9, wherein the authorizing access for the recipient is a reward to the recipient for at least one of: attending the event and loyalty to a subject contained within the visual content.

11. A processing system for content management and distribution, the system comprising:
at least one processing device; and
computer readable medium having executable instructions stored therein, the at least one processing device, in response to the executable instructions, operative to:
receive, via a first user interface, a plurality of data files, each data file including visual content therein;
receive event data associated with the data files, the event data identifying an event associated with the visual content;
receive author data associated with the plurality of digital data files, the author data identifying proprietary rights associated with the visual content;
present, via a second user interface, the visual content of each the plurality of data files to an authorizing user;
receive, via the second user interface, approval indicators for at least a portion of the plurality of data files, the approval indicator indicating approval by the authorizing user for authorizing use of the visual content;
generate an approved content data set including each of the plurality data files receiving the approval indicators; and
distribute at least one of the plurality of data files from the approved content data set including tracking the proprietary rights associated therewith and accounting for the distribution thereof.

12. The system of claim 11, wherein the distributing is to a commerce interface, the processing device further operative to:
display, in the commerce interface, the visual content of the one or more data files in the approved content data set in a display template and a plurality of commercial items for purchase capable of having the visual content imposed thereon.

13. The system of claim 12, the processing device further operative to:
approve at least one commercial transaction, via the commerce interface, for purchase of one of the plurality of commercial items having the visual content; and
track at least one royalty allocation based on the commercial transaction and the proprietary rights associated with the visual content.

14. The system of claim 12, the processing device further operative to:
receive a first selection of one of the commercial items;
receive a second selection of one of the visual content items;
generate a graphical display of the commercial item of the item of the first selection having the visual content item of the second selection overlayed thereon;
receive a third selection of another visual content item different from the visual content item of the second selection; and
update the graphical display of the commercial item replacing the item of the second selection with the item of third selection.

15. The system of claim 12, the processing device further operative to:
apply an overlay template associating the visual content with a graphical indicator of the event, wherein the commercial transaction includes the visual content with the graphical indicator of the event.

16. The system of claim 11, wherein the proprietary rights associated with the visual content include at least one of: authorship rights relating to acquisition of the visual content; name, image, and likeness rights relating to a subject captured in the visual content; performance rights relating to an artist captured in the visual content; and organization rights relating to an organization commissioning the event.

17. The system of claim 11, the processing device further operative to:
generate a unique identifier associated with the event;
distribute the unique identifier to a recipient based on attendance at the event by the recipient; and
authorize access for the consumer to the web commerce interface based on the unique identifier.

18. The system of claim 11, wherein tracking the proprietary rights, as executed by the processing device, further includes:
determining a royalty rate associated with the proprietary rights;
tracking fees generated using visual content of the approved content data set; and
accounting for royalty payments based on the royalty rate.

19. The system of claim 11, wherein the distributing of the at least one of the plurality of data files includes the processing device operative to:
authorize access for a recipient to view visual content within the approved content data set.

20. The system of claim 19, wherein the authorizing access for the recipient is a reward to the recipient for at least one of: attending the event and loyalty to a subject contained within the visual content.
